(19) United States
(12) Patent Application Publication
(10) Pub. No.: US 2024/0031027 A1
(43) Pub. Date: Jan. 25, 2024

(54) OPTICAL TRANSCEIVER, OPTICAL COMMUNICATION APPARATUS, OPTICAL COMMUNICATION SYSTEM, AND METHOD OF DETERMINING NUMBER OF SUBCARRIERS

(71) Applicant: Fujitsu Limited, Kawasaki-shi (JP)

(72) Inventor: Taizo MAEDA, Kawasaki (JP)

(73) Assignee: Fujitsu Limited, Kawasaki-shi (JP)

(21) Appl. No.: 18/136,422

(22) Filed: Apr. 19, 2023

(30) Foreign Application Priority Data
Jul. 21, 2022 (JP) 2022-116310

(51) Int. Cl. H04B 10/2569; H04B 10/40; H04B 10/61

(52) U.S. Cl. CPC H04B 10/2569; H04B 10/40; H04B 10/6161

(57) ABSTRACT

An optical transceiver to which subcarrier modulation is applied includes a signal processor that monitors a differential group delay and polarization fluctuation of a transmission line for a predetermined period of time, and a control processor that determines, based on the monitoring results of the differential group delay and the polarization fluctuation, a number of subcarriers to be configured in the optical transceiver from among candidates of numbers of subcarriers configurable in the optical transceiver, the numbers of subcarrers configurable in the optical transceiver being determined depending on an ability of a signal processor of the optical transceiver.

### CROSS-REFERENCE TO RELATED APPLICATIONS

This application is based upon and claims priority to earlier Japanese Patent Application No. 2022-116310 filed Jul. 21, 2022, which is incorporated herein by reference in its entirety.

### FIELD

The present documents relate to an optical transceiver, an optical communication apparatus, an optical communication system, and a method of determining the number of subcarriers.

### BACKGROUND

In recent years, there has been a growing need with respect to high network traffic, and there has been demand for further improvement in transmission capacity per channel for optical communication systems. Some schemes conceivable for increasing the transmission capacity per channel include improving the multilevel order of quadrature amplitude modulation (QAM), and improving the baud rate of transmission signals. As the multilevel order of QAM modulation increases, the influence of noise becomes noticeable, and higher computational accuracy is required in signal processing. As the baud rate is increased, tolerance to differential group delay (DGD) and chromatic dispersion of the fiber optic transmission line tends to decrease, although the influence of noise or requirement for calculation accuracy is not so much as that in a higher order multilevel modulation. To maintain the DGD tolerance and chromatic dispersion tolerance, the circuit scale of a finite impulse response (FIR) filter in the signal processor has to be increased, which will result in increased power consumption.

In order to achieve a high baud rate, while suppressing the circuit size of the FIR filter from increasing, adopting a subcarrier modulation, which divides a data signal to be transmitted into multiple subcarriers by digital signal processing, has been discussed. See, for example, Patent Document 1 presented below.

The related art document known to the inventor is

### Patent Document 1: Japanese Patent Application Laid-open Publication No. 2019-193266.

In a conventional optical transceiver using a coherent digital signal processor (DSP), once the baud rate and the modulation format (or the order of multilevel modulation) that meet with the line rate of the network, and the forward error correction (FEC) redundancy have been determined, then the operation mode is established as a matter of course. To newly introduce subcarrier modulation, it is necessary to determine the number of subcarriers, in addition to the baud rate, the order of multilevel modulation, and the FEC redundancy. The relationship between the number of subcarriers and the tolerance to waveform distortion varies depending on the type of waveform distortion occurring in the fiber-optic transmission line, such as DGD, polarization fluctuation, or chromatic dispersion. The DGD tolerance can be improved by increasing the number of subcarriers; however, the polarization fluctuation tolerance will decrease, and the signal-to-noise ratio (SNR) will be degraded due to the increased polarization fluctuation. Because of such tradeoff relationship, it is not easy to determine the optimal number of subcarriers suitable for the state of the transmission line. In addition, the state of the transmission line always changes, and parameter values employed to design the transmission line do not agree with the real-time measured values in many cases. A certain amount of margin could be given to the transmission line design in consideration of changes in the transmission line, but the originally expected efficiency of the transmission line may not be fully achieved.

It is desired to provide a configuration and a scheme to determine the appropriate number of subcarriers according to the state of the transmission line in an optical communication system to which subcarrier modulation is applied.

### SUMMARY

In one embodiment, an optical transceiver to which subcarrier modulation is applied includes
a signal processor that monitors a differential group delay and polarization fluctuation of a transmission line for a predetermined period of time; and
a control processor that determines, based upon monitoring results of the differential group delay and the polarization fluctuation, a number of subcarriers to be configured in the optical transceiver from among candidates of numbers of subcarriers configurable in the optical transceiver, the numbers of subcarriers configurable in the optical transceiver being determined depending on an ability of a signal processor of the optical transceiver.

The object and advantages of the invention will be realized and attained by means of the elements and combinations particularly pointed out in the claims. It is to be understood that both the foregoing general description and the following detailed description are exemplary and explanatory and are not restrictive to the invention as claimed.

### BRIEF DESCRIPTION OF DRAWINGS

FIG. 1 is a schematic block diagram of an optical communication system according to an embodiment;

FIG. 2 is a schematic block diagram of an optical transceiver used in the system of FIG. 1;

FIG. 3 is a schematic diagram of a DSP in the optical transceiver of FIG. 2;

FIG. 4 illustrates a subcarrier multiplexed signal band, in comparison with a single carrier signal band;

FIG. 5 illustrates a relationship between the number of subcarriers, DGD tolerance, polarization fluctuation tolerance, and SNR degradations;

FIG. 6 illustrates a relationship between DGD and SNR with different numbers of subcarriers;

FIG. 7 illustrates a relationship between polarization fluctuation and SNR degradation with different numbers of subcarriers;

FIG. 8 illustrates a reason why polarization fluctuation followability deteriorates when subcarrier modulation is employed;

FIG. 9 is a flowchart of a method of determining the number of subcarriers according to the first embodiment;

FIG, 10 illustrates a configuration example of a dynamic equalizer;

FIG. 11 is a schematic diagram of an adaptive equalization filter used in the dynamic equalizer of FIG. 10;

FIG. 12 illustrates a step-size dependency of polarization fluctuation tolerance; and

FIG. 13 illustrates the relationship between the number of subcarriers, baud rate per subcarrier (referred to as “subcarrier baud rate”), DGD tolerance, and polarization fluctuation tolerance;

FIG. 14 illustrates a comparison between a theoretical design and a method of the first embodiment for determining the number of subcarriers;

FIG. 15 illustrates improvement in polarization fluctuation tolerance by the method of determining the number of subcarriers according to the first embodiment;

FIG. 16 illustrates another comparison between the theoretical design and the method of the first embodiment for determining the number of subcarriers;

FIG. 17 illustrates a difference in network configuration between the theoretical design of FIG. 16 and the method of the first embodiment;

FIG. 18 is a flowchart of a method of determining the number of subcarriers according to the second embodiment;

FIG. 19 illustrates a relationship between the number of subcarriers, subcarrier baud rate, DGD tolerance of the DSP, polarization fluctuation tolerance, and chromatic dispersion;

FIG. 20 illustrates a comparison between a theoretical design and a method of the second embodiment for determining the number of subcarriers;

FIG. 21 illustrates a relationship between the number of subcarriers, DGD tolerance, polarization fluctuation tolerance, and SNR degradation;

FIG. 22 is a flowchart of a method for determining the number of subcarriers according to the third embodiment;

FIG. 23 illustrates a relationship between the number of subcarriers, subcarrier baud rate, DGD tolerance of the DSP, polarization fluctuation tolerance, and chromatic dispersion;

FIG. 24 illustrates a tradeoff between causes of degradation of received Q factor; and

FIG. 25 illustrates a comparison between a theoretical design and a method of the third embodiment for determining the number of subcarriers.

### EMBODIMENTS

The relationship between the number of subcarriers used for subcarrier modulation and the tolerance of a waveform distortion factor, such as DGD tolerance, polarization fluctuation tolerance, or chromatic dispersion tolerance, of a fiber-optic transmission line differs depending on the type of the waveform distortion factor. There is also a correlation between the number of subcarriers and the tolerance with respect to the nonlinear optical effects. In the embodiment, waveform distortion factors of the transmission line, including at least

DGD and polarization fluctuation, are monitored for a predetermined period of time using the monitoring function of the DSP of an optical transceiver, and candidates of the number of subcarriers are narrowed down based on the monitoring results. The optimum number of subcarriers is determined from the narrowed candidate group.

The polarization state of the fiber-optic transmission line changes due to a temperature change or vibration caused in the optical fiber, and therefore, DGD and polarization fluctuation are monitored for a certain period of time, for example, 24 hours (one day). Then, the maximum DGD during the monitoring period is used as the reference. The numbers of subcarriers that can deal with the maximum DGD are selected as the first candidate group from among the numbers of subcarriers, such as 1, 2, 4, 8, . . . , or 2\hat{ }n, configurable in an optical transceiver. Lastly, the minimum number of subcarriers that can deal with the maximum polarization fluctuation is determined as the number of subcarriers to be configured, from the first candidate group.

Chromatic dispersion may be monitored, in addition to the DGD and polarization fluctuation, for a certain period of time, for example, one day. In this case, the numbers of subcarriers that can deal with the maximum DGD are selected as the first candidate group from among the numbers of subcarriers configurable in an optical transceiver, and then, the second candidate group which can deal with the maximum chromatic dispersion is selected from the first candidate group. Then, either one of the minimum number of subcarriers or the number of subcarriers with the highest Q factor is selected as the number of subcarriers to be configured, from among the second candidate group.

The grounds for the above-described schemes for determining the number of subcarriers will be explained in more detail with reference to the appended drawings. In the drawings, the same configurational elements are denoted by the same reference numerals, and redundant explanation may be omitted. In the following description, “polarization fluctuation” means “polarization fluctuation rate” (kHz) unless otherwise specified.

### System Configuration

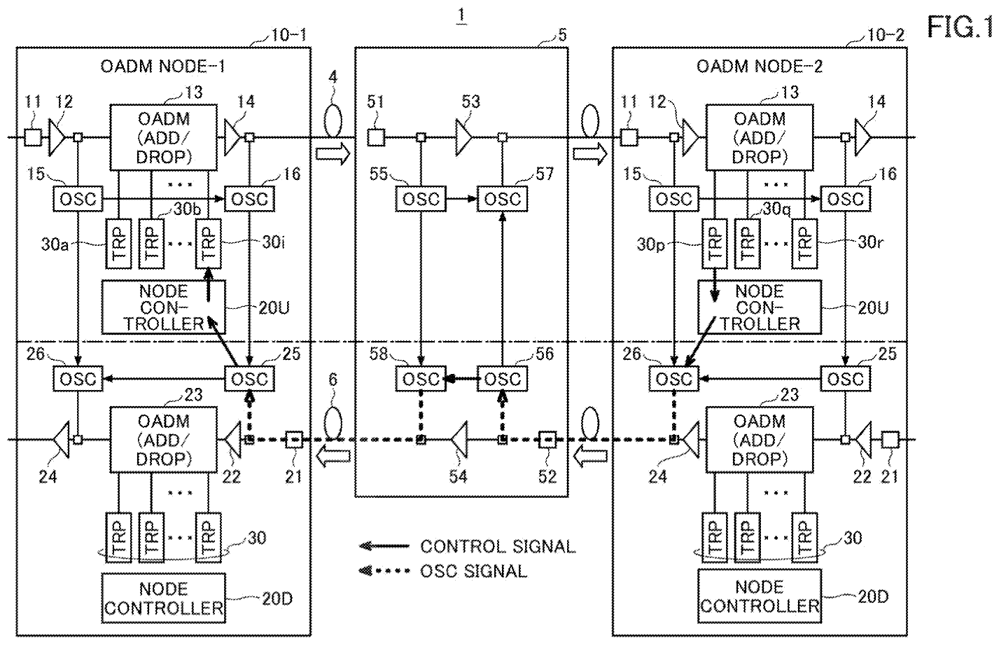

FIG. 1 is a schematic diagram of an optical communication system 1 according to an embodiment. The optical communication system 1 is a wavelength division multiplexing (WDM) communication system, and it includes optical communication apparatuses 10-1 and 10-2 connected by fiber optic transmission lines 4 and 6 (hereinafter referred to simply as “transmission lines 4 and 6”). One or more relay nodes 5 may be inserted in the transmission lines 4 and 6. Each of the optical communication apparatuses 10-1 and 10-2 is, for example, a communication apparatus having an optical add and drop multiplexing (OADM) function for adding or dropping a signal with a specific wavelength. In this sense, the optical communication apparatuses 10-1 and 10-2 are denoted as “OADM NODE-1” and “OADM NODE-2” in the figure. The optical communication apparatuses 10-1 and 10-2 have the same configuration, and therefore, they may be collectively referred to as “optical communication apparatuses 10”.

The optical communication apparatus 10 is capable of bi-directional communication. The channel entering the optical communication apparatus 10 from the left side and exiting to the right side of the figure is called an “uplink channel”, and the channel entering the optical communication apparatus 10 from the right side and exiting to the left side of the figure is called a “downlink channel” in this example. The relay node 5 amplifies optical signals passing through in both directions along the uplink transmission line 4 and the downlink transmission line 6. Although only one relay node 5 is illustrated for convenience of illustration, two or more relay nodes 5 may be provided between the optical communication apparatuses 10-1 and 10-2.

The optical communication apparatus 10 has an optical attenuator 11, a preamplifier 12, an optical add/drop multiplexer (denoted as “OADM” in the figure) 13, a post-amplifier 14, and a node controller 20U for the uplink channel. The OADM 13 is connected to a plurality of optical transceivers 30a, 30b, . . . , 30i, which are, for example, optical transponders each having a function of optical-to-electrical and electrical-to-optical conversion and being denoted as “TRP” in the figure. The optical communication apparatus 10 has an optical attenuator 21, a preamplifier 22, an OADM 23, a post-amplifier 24, and a node controller 20D for the downlink channel. A plurality of optical transceivers 30 are connected to the OADM 23. The node controllers 20U and 20D may be implemented by a common processor.

The optical communication apparatus 10 has optical supervisory channel (OSC) processors 15 and 16 for the uplink channel. The OSC processor 15 demodulates the optical supervisory signal extracted from the input of the OADM 13. The OSC processor 16 generates an OSC signal which is to be superimposed onto the optical signal output from the OADM 13. The optical communication apparatus 10 has OSC processors 25 and 26 for the downlink channel. The OSC processor 25 demodulates the OSC signal extracted from the input of the OADM 23. The OSC processor 26 generates an OSC signal which is to be superimposed onto the optical signal output from the OADM 23. The relay node 5 has OSC processors 55, 56, 57, and 58, each of which performs optical-to-electrical conversion or electrical-to-optical conversion on the OSC signals, and relays the OSC signals in a predetermined direction.

On the uplink channel, a portion of the WDM signal input to the OADM 13 of the optical communication apparatus 10-1 is routed into a different network path, and an optical signal dropped by the OADM 13 and terminated at the optical communication apparatus 10-1 is input to the associated optical transceiver 30 (for example, the optical transceiver 30a). An optical signal output from, for example, the optical transceiver 30i is added to the WDM signal passing through the optical communication apparatus 10-1 on the uplink channel, amplified by the post-amplifier 14, and output to the transmission line 4.

The WDM signal travelling through the transmission line 4 is power-adjusted by the optical attenuator 51 of the relay node 5, amplified by the in-line amplifier 53, and keeps on travelling through the transmission line 4 on the uplink channel. The WDM signal received by the optical communication apparatus 10-2 is power-adjusted by the optical attenuator 11, amplified by the preamplifier 12, and input to the OADM 13. A portion of the WDM signal input to the OADM 13 is routed into a different network path, and an optical signal dropped by the OADM 13 and terminated at the optical communication apparatus 10-2 is supplied to a target optical transceiver 30 (for example, an optical transceiver 30p). An optical signal from an optical transceiver 30r may be added to the WDM signal passing through the optical communication apparatus 10-2 on the uplink channel, and output to the uplink transmission line 4. Reversed operations are performed on the downlink channel.

Consideration is made to a case where the optical communication apparatus 10-1 is to accommodate an additional wavelength, that is, a case where a subcarrier modulation based new optical transceiver 30i is to be connected to the optical communication apparatus 10-1. An appropriate number of subcarriers has to be set in the new optical transceiver 30i for performing subcarrier modulation according to the polarization state of the transmission line 4. In this case, the monitoring function of the DSP of the optical transceiver 30p accommodated in the optical communication apparatus 10-2 is used to monitor the transmission line 4 for a certain period of time. The optical transceiver 30p determines the optimal number of subcarriers to be set in the new optical transceiver 30i based on the monitoring result. The number of subcarriers determined by the optical transceiver 30p is sent to the OSC processor 26 via the node controller 20U, and notified to the optical communication apparatus 10-1 via the transmission line 6 using an OSC signal.

The notification of the number of subcarriers contained in the OSC signal is relayed by the relay node 5 to the optical communication apparatus 10-1. The OSC signal received by the optical communication apparatus 10-1 is demodulated by the OSC processor 25 and notified to the optical transceiver 30i by the node controller 20U. The optical transceiver 30i configures the notified number of subcarriers in the DSP.

### Configuration of Optical Transceiver

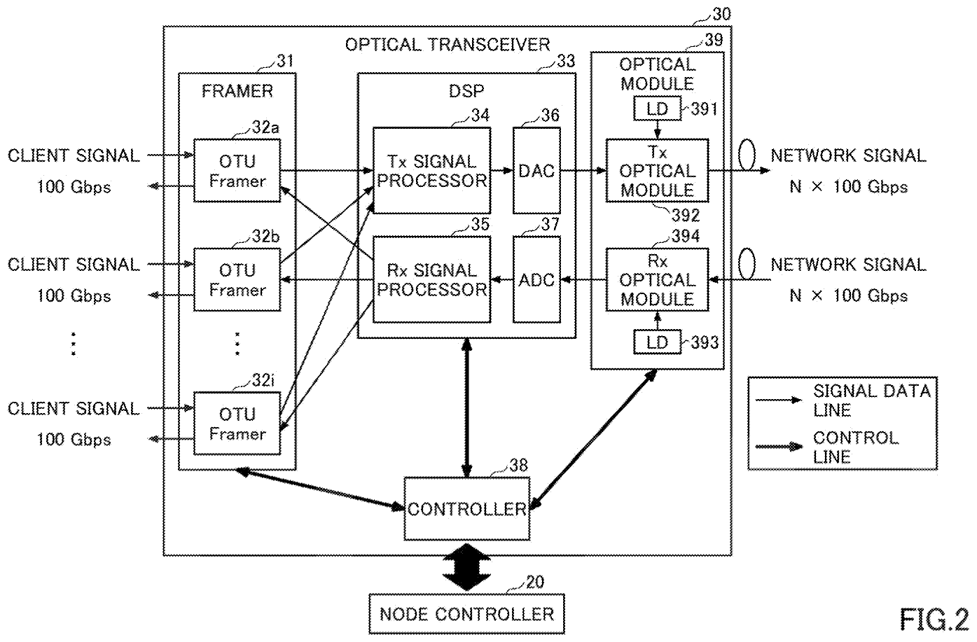

FIG. 2 is a schematic block diagram of the optical transceiver 30 used in FIG. 1. An example of the optical transceiver 30 is a transponder, as illustrated in FIG. 1. The optical transceiver has a DSP 33, a controller 38, a framer 31 connected to the client side, and an optical module 39 connected to the network side. The DSP 33 is an example of a signal processor. The framer 31 and the DSP 33 may be separately configured using individual large-scale integrated circuits (LSICs). The optical module 39 may be formed of a photonic integrated circuit (PIC). The controller 38 may be implemented by a microprocessor, a field programmable gate array (FPGA), or another logic device. Control signals are sent and received between the controller 38 and the node controller 20 of the optical communication apparatus 10.

The framer 31 has a plurality of optical-channel transport unit (OTU) framers 32a, 32b, . . . , 32i, which may be collectively referred to as “OTU framers 32. Each of the OTU framers 32 performs coding and decoding on the associated client signal to and from OTU frames used in the network. The DSP 33 includes a transmitter side (denoted as “Tx” in the figure) signal processor 34, a receiver side (denoted as “Rx” in the figure) signal processor 35, a digital-to-analog converter (DAC) 36, and an analog-to-digital converter (ADC) 37. A signal generated by the signal processor 34 is converted into an analog electric signal by the DAC 36, and converted into an optical signal by an optical front end module (denoted simply as “optical module” in the figure) 392 at the transmitter side of the optical module 39. The network capacity is represented as “N×100 Gbps” where N denotes the number of connections of client signals. The transmission rate of 100 Gbps is only an example, and it may be 200 Gbps. An optical signal received from the network is converted into an electrical signal by the optical front end module 394 at the receiver side, digitalized by the ADC 37 of the DSP 33, and decoded by the Rx signal processor 35. A light source (denoted as “LD” in the figure) 391 for generating a carrier wave, and a light source 393 for signal detection in the Rx optical module 39 may be the same light source.

The Tx signal processor of the DSP 33 has a subcarrier demultiplexing function for subcarrier modulation. The Rx signal processor 35 has a subcarrier multiplexing function for subcarrier modulation and a transmission line monitoring function. Upon introduction of a new optical transceiver 30i (see FIG. 1) into the network, the Rx signal processor 35 of the DSP 33 of the optical transceiver 30p, which is connected at the opposite side of the transmission line 4, monitors the transmission line 4. The controller 38 of the optical transceiver 30p determines an appropriate number of subcarriers to be configured in the optical transceiver 30i newly introduced at the opposite side, based on the monitor result acquired at the DSP 33.

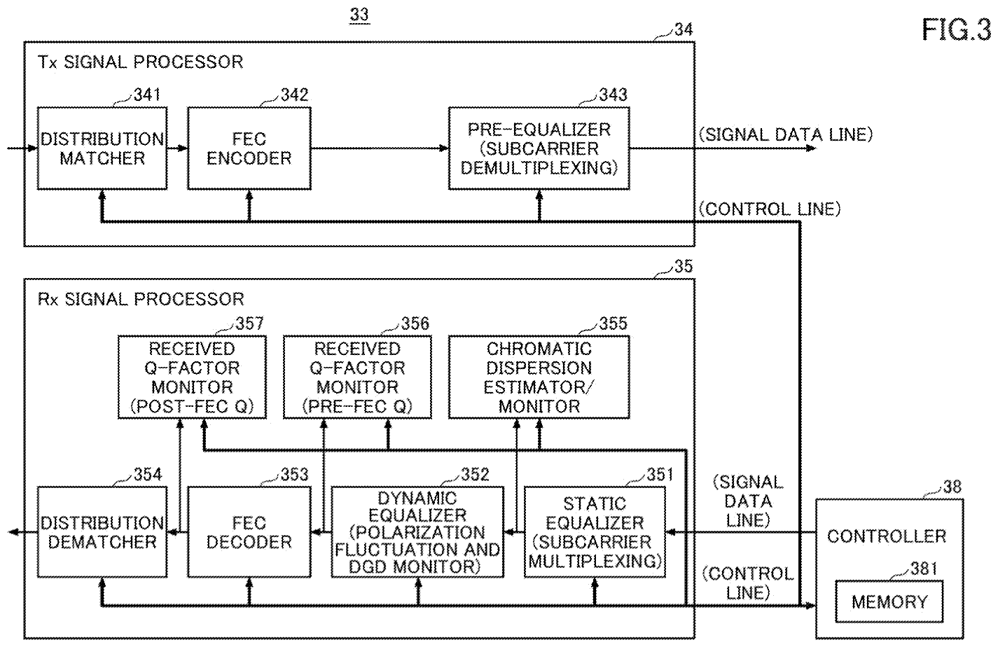

FIG. 3 is a schematic diagram of the DSP 33. In the figure, arrows indicate signal data lines, and thick arrows indicate control lines. The Tx signal processor 34 and the Rx signal processor 35 are connected to the controller 38 via control lines. The controller 38 may be a logic device having a built-in memory 381.

The Tx signal processor 34 has a distribution matcher 341, an FEC encoder 342, and a pre-equalizer 343. The distribution matcher 341 performs probabilistic constellation shaping to the input data signal to shape the probability distribution of the amplitudes of the constellation symbols into a distribution suitable for the transmission line. The FEC encoder 342 performs error correction and coding on the signal having been subjected to the probability constellation shaping. A pre-equalizer 343 compensates for chromatic dispersion, frequency offset, and/or nonlinear characteristics. Such nonlinear characteristics include electrical nonlinearity appearing in the analog output of the DAC 36 or the analog input to the optical front end module 392. In addition to the compensation for these factors, the pre-equalizer 343 divides the data signal to be transmitted into the configured number of subcarriers. If the number of subcarriers is one (1), a single-carrier signal band is used without demultiplexing.

The Rx signal processor 35 has a static equalizer 351, a dynamic equalizer 352, an FEC decoder 353, a distribution dematcher 354, a chromatic dispersion estimator/monitor 355, and received Q-factor monitors 356 and 357. The static equalizer 351 multiplexes the subcarriers input to the Rx signal processor 35, and performs equalization on the frequency axis. The chromatic dispersion estimator/monitor 355 estimates and compensates for chromatic dispersion, that is, wavelength-dependence of the speed of propagation. When the optical transceiver 30i is newly introduced in the network at the opposite end of the transmission line 4, the chromatic dispersion monitoring function of the chromatic dispersion estimator/monitor 355 is used to monitor the chromatic dispersion of the transmission line for a certain period of time.

The dynamic equalizer 352 performs frequency offset compensation, polarization mode dispersion compensation, and carrier phase recovery on the time axis on the chromatic-dispersion-compensated signal. When the optical transceiver 30i is newly introduced into the network, the monitoring function of the dynamic equalizer 352 is used to monitor the polarization fluctuation and DGD of the transmission line for a certain period of time.

The received Q-factor monitor 356 monitors the Q-factor of the dynamically equalized signal before FEC decoding. The received Q-factor monitor 357 monitors the Q-factor after the FEC decoding performed by the FEC decoder 353. A distribution dematcher 354 estimates the signal amplitude that has not undergone the probability constellation shaping.

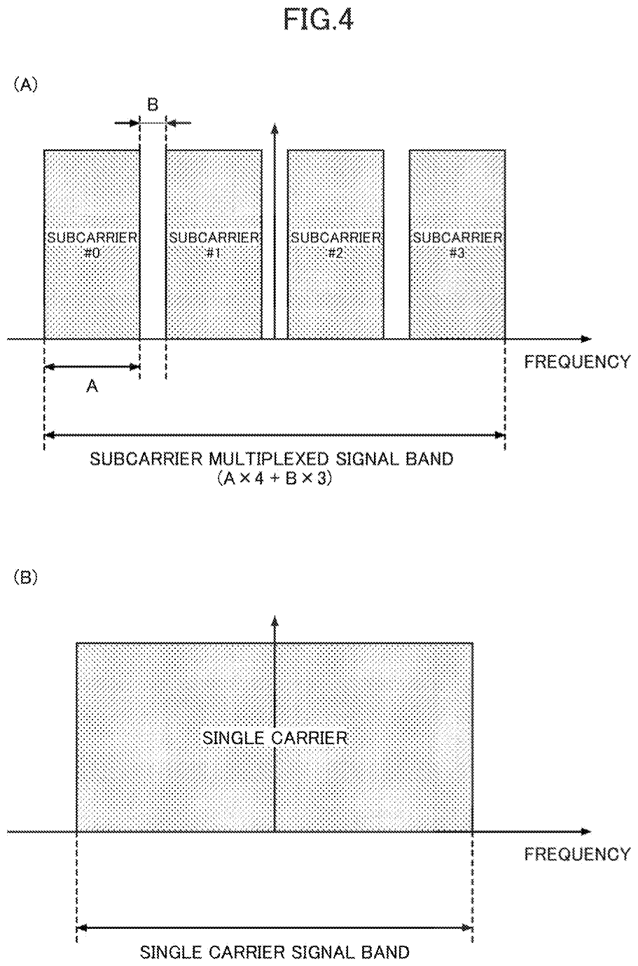

FIG. 4 illustrates a signal band used for subcarrier modulation, compared with a signal band used for signal carrier transmission. As has been described above, the Tx signal processor 34 of the DSP 33 divides the data signal to be transmitted into one or more subcarriers for frequency division multiplexing transmission. The Rx signal processor 35 separates the subcarriers from the frequency division multiplexed signal and combines the data signals prior to various signal processing. Unlike super-channel transmission, which forms multiple subcarriers using a plurality of transceivers, a given signal band is divided and combined at one optical transceiver 30.

(A) part of FIG. 4 illustrates an example of multiplexing of four subcarriers #0, #1, #2, and #3. The baud rate per subcarrier is denoted as “A”. Spacing B is provided between adjacent subcarriers to ensure transmission performance. The total signal band width required for the 4-subcarrier transmission is slightly wider than that for the single carrier transmission illustrated in (B) part of FIG. 4. The signal band for single carrier transmission needs four times the baud rate per subcarrier (A×4) in the (A) part of FIG. 4. Subcarrier multiplexing transmission requires extra bandwidth corresponding to the subcarrier spacing (B×3), compared with the (B) part of FIG. 4.

By dividing the data signal to be transmitted into subcarriers, the DGD tolerance and chromatic dispersion tolerance are improved, and the tolerance to nonlinear optical effects is improved in long-distance, low-multilevel signal transmission. On the other hand, followability to the polarization fluctuation deteriorates. The tradeoff relationship between the number of subcarriers and the transmission characteristics found by the inventor will be described in more detail below.

### Tradeoff Between the Number of Subcarriers and Transmission Characteristics

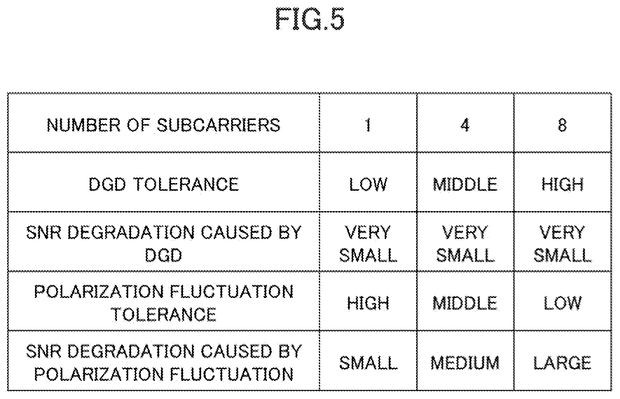

FIG. 5 illustrates the tradeoff relationship among the number of subcarriers, DGD tolerance, polarization fluctuation tolerance, nonlinear optical effect tolerance, and SNR degradation. As the number of subcarriers increases from 1 to 4 and to 8, the DGD tolerance is improved, while the SNR degradation caused by DGD is kept very small regardless of the number of subcarriers. On the other hand, as the number of subcarriers increases, the polarization fluctuation tolerance decreases, and the SNR degradation caused by polarization fluctuation increases. The SNR degradation due to nonlinear optical effects increases as the number of subcarriers decreases. It should be noted that there is a lower limit to the baud rate per subcarrier (called “subcarrier baud rate”) with respect to the tolerance to nonlinear optical effects. The lower limit of the subcarrier baud rate is about 10 Gbaud.

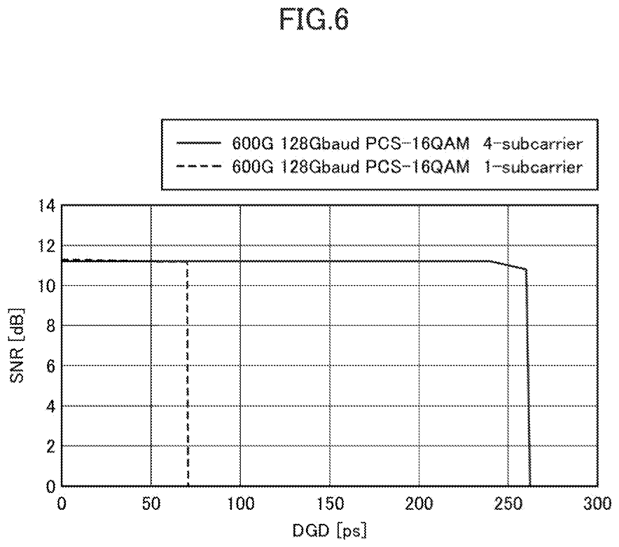

FIG. 6 illustrates the relationship between DGD [ps] and SNR [dB] for different numbers of subcarriers. For the numbers of subcarriers of 1 and 4, a 16 QAM signals having been subjected to probabilistic constellation shaping (PCS) is used. The transmission rate is 600 Gbps and the baud rate is 128 Gbaud for both the 4-subcarrier configuration and the 1-subcarrier configuration. While the DGD tolerance with one subcarrier is about 60 to 70 ps, the DGD tolerance increases to 250 ps or more with four subcarriers, which is about four times higher than that of single carrier.

This is because the DGD tolerance is inversely proportional to the baud rate or symbol rate. Assuming that the number of samplings per symbol is the same, if the symbol rate (symbols per second) is reduced to ½, the sampling rate (samples per second) also decreases to ½. DGD can be compensated for by an FIR filter. If the sampling rate is reduced to ½, the compensation range or the time window of the FIR filter is doubled under the condition that the number of taps of the FIR filter is constant, and approximately double the amount of DGD can be compensated. In the case of four-subcarrier configuration illustrated in FIG. 6, the symbol rate of each subcarrier is quarter (¼) of that of single carrier, and the DGD tolerance is approximately four times the single carrier. If two subcarriers are used, the symbol rate of each subcarrier is half (½) of that of the single carrier, and the DGD tolerance is approximately doubled compared with the single carrier.

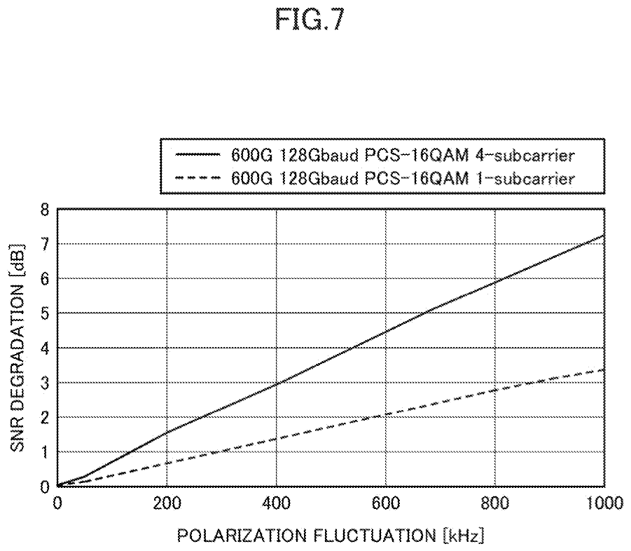

FIG. 7 illustrates the relationship between polarization fluctuation (kHz) and SNR degradation (dB) with different numbers of subcarriers. For both the numbers of subcarriers of 1 and 4, a 16 QAM signal having undergone probabilistic constellation shaping us used. The transmission rate and baud rate are 600 Gbps and 128 Gbaud, respectively. With the same amount of polarization fluctuation, four-subcarrier configuration have a more pronounced SNR degradation than a single-carrier configuration, and the polarization fluctuation followability deteriorates.

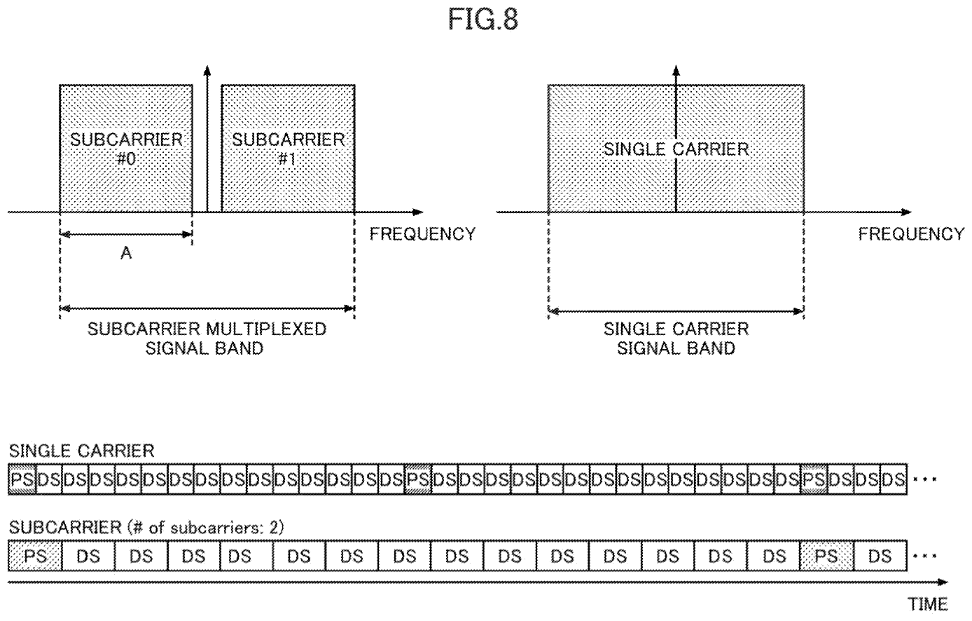

FIG. 8 illustrates a reason why the polarization fluctuation followability deteriorates when subcarrier modulation is employed. In subcarrier modulation, the subcarrier baud rate “A” is lower than that of single carrier transmission. For example, using two subcarriers, the subcarrier baud rate is ½ of the single carrier baud rate. Representing the transmission codes, namely the flow of symbols, along the time axis, control pilot symbols PS are inserted into data symbols DS at regular intervals for the purpose of tracking polarization fluctuation. For two- subcarrier configuration, the interval between the pilot symbols PS is doubled, compared with single carrier transmission, and the polarization fluctuation tracking rate decreases.

Due to these tradeoff relationships, it is not easy to determine the appropriate number of subcarriers. In the embodiment, the transmission line is monitored for a certain period of time to determine the optimum number of subcarriers capable of dealing with waveform distortion factors that are in tradeoff relationships.

### First Embodiment

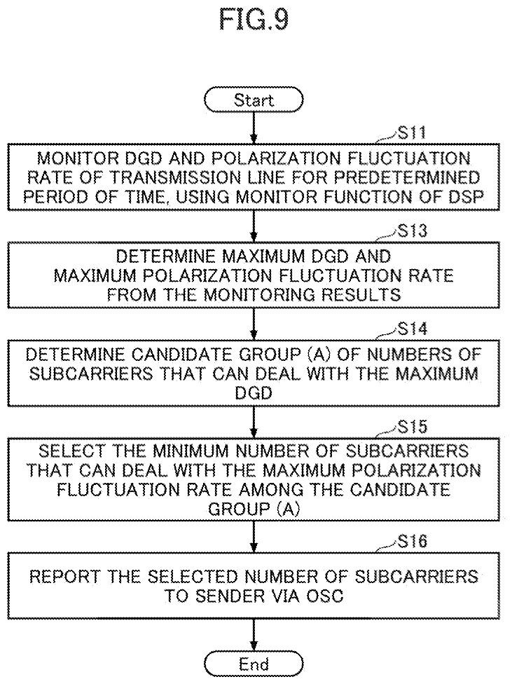

FIG. 9 is a flow chart of a method of determining the number of subcarriers according to the first embodiment. This operation flow is performed by an optical transceiver 30 represented by, for example, the optical transceiver 30p illustrated in FIG. 1. The optical transceiver 30 monitors the DGD and the polarization fluctuation rate of the transmission line for a certain period of time, using the monitor function of the Rx signal processor 35 of the DSP 33 (S11). During this period of time, the counterpart optical transceiver 30i (see FIG. 1) newly introduced into the network may transmit a test signal, in which a known training sequence is contained, to the transmission line 4. The test signal may be transmitted using multiple subcarriers, the number of which has been configured by default in the newly introduced optical transceiver 30i, or it may be transmitted using a single carrier without demultiplexing the data signal into subcarriers, because the state of the transmission line itself is not affected by the number of subcarriers being used. The number of subcarriers included in the test signal does not affect the monitoring result of the transmission line 4 because the subcarriers received from the transmission line 4 are multiplexed prior to the monitoring and measurement performed by the Rx signal processor 35.

The DGD and the polarization fluctuation of the transmission line changes over time. Polarization fluctuation also varies due to external factors including vibration and temperature change. Therefore, the transmission line is monitored for a predetermined period of time sufficient to know the change in the transmission line, one example being 24 hours. A dynamic equalizer 352 of the Rx signal processor 35 can monitor the DGD and the polarization fluctuation rate of the transmission line. The dynamic equalizer 352 calculates the polarization fluctuation rate and the DGD from the filter coefficients set in the adaptive equalization filter.

FIG. 10 illustrates a configuration example of the dynamic equalizer 352. The dynamic equalizer 352 includes a carrier frequency and phase synchronization block 3521, an adaptive equalization filter 3522, an adaptive equalization coefficient calculator 3523, a polarization fluctuation monitor 3524, a step size selector 3525, and a sampling clock synchronization block 3526. The signal received and having undergone dispersion compensation is subjected to frequency offset compensation in carrier frequency and phase synchronization block 3521, and to polarization mode dispersion and polarization fluctuation compensation in adaptive equalization filter 3522. Then carrier phase adjustment is performed by sampling clock synchronization block 3526 to recover the transmitted signal.

The adaptive equalization filter 3522 is, for example, an FIR filter. The adaptive equalization coefficient calculator 3523 calculates filter coefficients of the adaptive equalization filter 3522. The polarization fluctuation monitor 3524 acquires the monitored value of the polarization fluctuation rate from the filter coefficients. The step size selector 3525 selects the optimum step size for the monitored value of the polarization fluctuation.

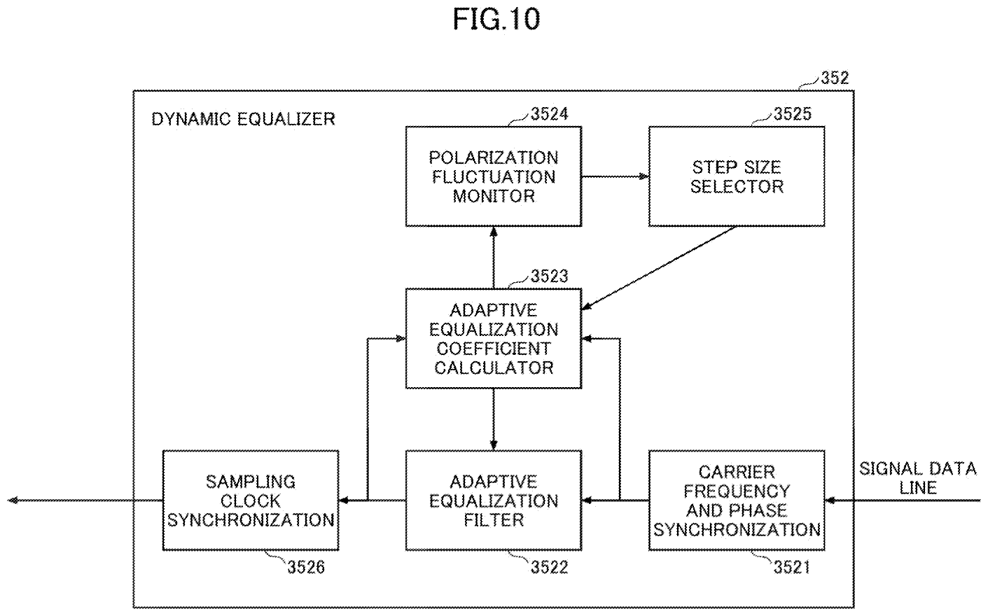

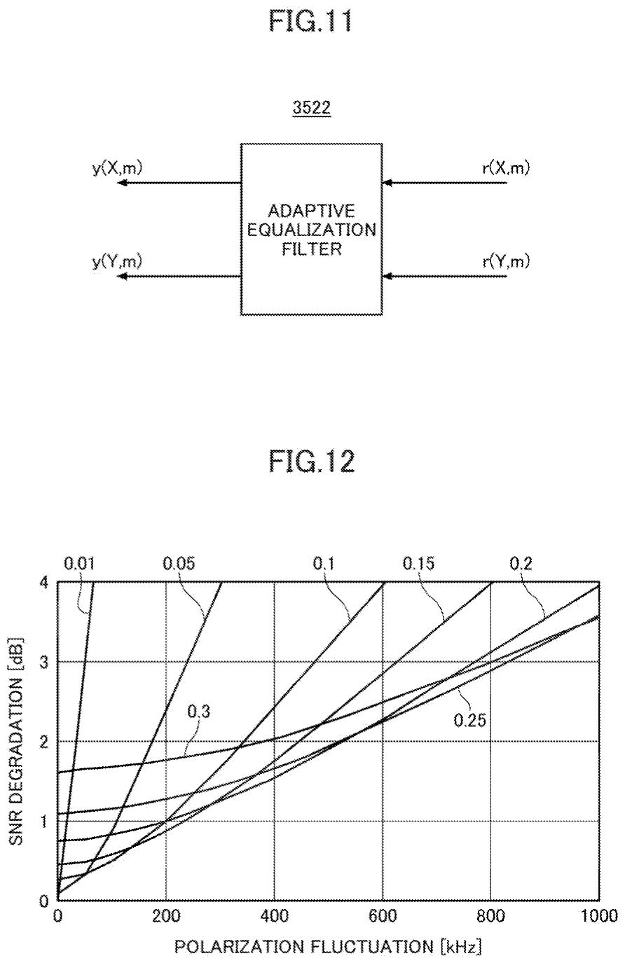

FIG. 11 is a schematic diagram of the adaptive equalization filter 3522, and FIG. 12 illustrates the step size dependence of the polarization fluctuation tolerance. An input signal to the adaptive equalization filter 3522 is represented by r( ), and an output signal of the adaptive equalization filter 3522 is represented by y( ). At time m, the adaptive equalization filter 3522 receives X-polarized and Y-polarized signals.

The adaptive equalization coefficient calculator 3523 calculates the tap coefficients of the adaptive equalization filter 3522 according to the following formula.

wₘ₊₁=wₘ−μr*ₘ(|yₘ|²−γ)yₘ

where Wₘ is the filter tap coefficient vector at time m, rₘ is the filter input signal, yₘ is the filter output signal, μ is the step size, and γ is a constant. The step size μ indicates the strength of the feedback.

Referring to FIG. 12, the greater the step size, the better the followability to high-rate polarization fluctuation, but the lower the noise tolerance. The step size selector 3525 selects the optimum step size according to the polarization fluctuation rate, based on the monitoring result acquired from the polarization fluctuation monitor 2524 and the noise characteristics illustrated in FIG. 12. The characteristics of FIG. 12 may be saved as a lookup table or function in the memory area of step size selector 3525.

The adaptive equalization coefficient calculator 3523 calculates tap coefficients based on the selected step size. By setting the optimum step size according to the polarization fluctuation rate, monitoring accuracy of the polarization fluctuation monitor 3524 can be maintained. Even if the optimum step size is selected, the SNR degradation tends to increase as the polarization fluctuation increases, that is, the OSNR tolerance tends to decrease. The polarization fluctuation monitor 3524 supplies the polarization fluctuation rate and the DGD to the controller 38 via the control line (see FIG. 3).

Returning to FIG. 9, the controller 38 determines the maximum values of the DGD and the polarization fluctuation rate in the monitoring period of time from the monitoring results of the DGD and the polarization fluctuation rate (S13). A candidate group (A) of the numbers of subcarriers that can deal with the maximum DGD value (S14). DGD tolerance and polarization fluctuation tolerance are determined in advance corresponding to each number of subcarriers by the design of the optical transceiver 30.

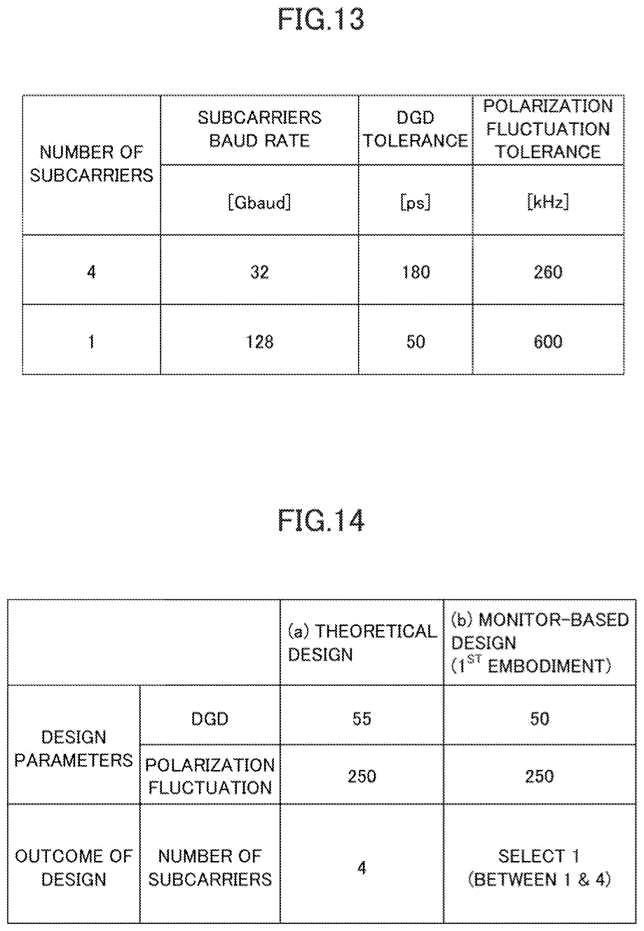

FIG. 13 illustrates the relationship among the number of subcarriers, the subcarrier baud rate, the DSP's DGD tolerance, and the polarization fluctuation tolerance, which are determined depending on the ability of the DSP 33. The operating modes of the transceiver are 600 Gbps, PCS-16 QAM, and 128 Gbaud. With the number of subcarriers of 4, the subcarrier baud rate is 32 Gbaud, the DGD tolerance is 180 ps, and the polarization fluctuation tolerance is 260 kHz. With the number of subcarriers of 1, the subcarrier baud rate is 128 Gbaud, the DGD tolerance is 50 ps, and the polarization fluctuation tolerance is 600 kHz. Although only the cases with the numbers of subcarriers of 1 and 4 are exemplified in the figure, the subcarrier baud rate, the DGD tolerance, and the polarization fluctuation tolerance are determined for the number of subcarriers 2\hat{ }n, where n is an integer greater than or equal to 0, according to the ability of the DSP 33.

Returning to FIG. 9, the minimum number of subcarriers that can deal with the maximum polarization fluctuation rate of the transmission line is selected from among the candidate group (A) of the numbers of subcarriers (S15). By selecting the minimum number of subcarriers, SNR degradation can be minimized, while maintaining the received signal quality, as illustrated in FIG. 5. At this stage, the number of subcarriers to be configured in the newly introduced optical transceiver 30i is determined. The determined number of subcarriers is reported via OSC to the optical communication apparatus 10-1 to which the optical transceiver 30i is newly connected, thereby configuring the number of subcarriers at both the transmitter side and the receiver side (S16).

FIG. 14 illustrates a comparison between a theoretical design based determination result of the number of subcarriers and the monitor based determination result of the number of subcarriers according to the first embodiment. The theoretical design of (a) determines the number of subcarriers by calculation without monitoring the transmission line. The monitor based design (b) is a scheme of the first embodiment in which the transmission line is monitored for a certain period of time to choose the number of subcarriers that can minimize the SNR deterioration, while coping with both the maximum DGD and the maximum polarization fluctuation of the transmission line.

With the theoretical design, the maximum DGD of the transmission line is calculated as 55 ps, but the actual value of the maximum DGD is 50 ps according to the monitoring results. The maximum polarization fluctuation is 250 kHz for both the theoretical design and the monitor-based design. Referring to the DSP's ability illustrated in FIG. 13, the polarization fluctuation tolerance is greater than 250 kHz when the number of subcarriers is either 1 or 4, and accordingly, any number of subcarriers can be selected regarding the polarization fluctuation. On the other hand, the DGD tolerance with the number of subcarrers of 1 is 50 ps, which cannot handle the maximum DGD of 55 ps determined by the theoretical design. Therefore, 4-subcarrier multiplexing is to be selected.

In contrast, a candidate group (A) including the numbers of subcarriers that can deal with the maximum DGD is determined according to the method of the first embodiment. In the example of FIG. 13, the numbers of subcarriers of both 1 and 4 are selected as the candidate group (A). Then, the minimum number of subcarriers that can deal with the maximum polarization fluctuation is selected from the candidate group (A). Since the numbers of subcarriers of both 1 and 4 can deal with the maximum polarization fluctuation of 250 kHz, 1 subcarrier, which is the minimum number of subcarriers, is selected.

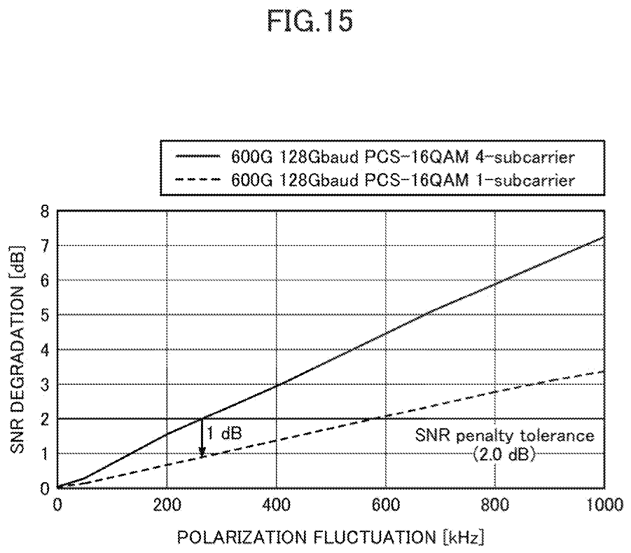

FIG. 15 illustrates an improvement in polarization fluctuation tolerance achieved by the method of determining the number of subcarriers according to the first embodiment. If the 4-subcarrier configuration is selected by the theoretical design, the SNP penalty will exceed the allowable range (2.0 dB for example) upon the polarization fluctuation exceeding 260 kHz. On the other hand, by selecting 1-subcarrier configuration according to the embodiment, there is a margin of 1 dB with respect to the SNR penalty at the polarization fluctuation of 260 kHz. This margin can be allocated to increase the transmission capacity. For example, the transmission rate can be increased from 600 Gbps to 650 Gbps.

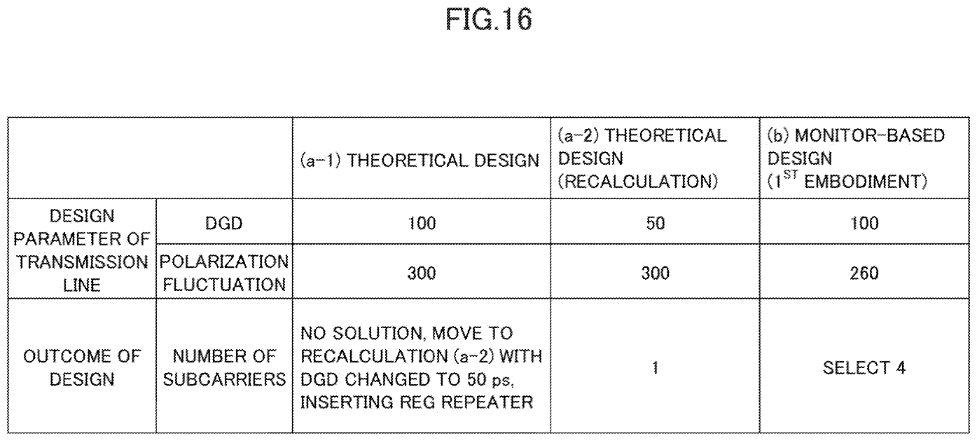

FIG. 16 illustrates another comparison between the theoretical design and the scheme of the first embodiment for determining the number of subcarriers. The DSP performance determined by the number of subcarriers is the same as that illustrated in FIG. 13. In FIG. 16, the theoretical design (a-1) is made using the parameters of the polarization fluctuation of 300 kHz and the DGD at 100 ps of the transmission line. With this design, there is no solution, and accordingly, recalculation is performed according to the theoretical design (a-2) by providing the regenerative repeater REG on the transmission line.

Recalculation is made in the theoretical design (a-2) by setting the DGD to 50 ps and the polarization fluctuation to 300 kHz. Then, the DSP having the performance illustrated in FIG. 13 cannot cope with the polarization fluctuation when the number of subcarriers is 4. Consequently, the number of subcarriers of 1 is selected.

In contrast, with the monitor-based design according to first embodiment, the maximum DGD and the maximum polarization fluctuation of the transmission line is 100 ps and 260 kHz, respectively. According to the DSP performance in FIG. 13, 1-subcarrier configuration cannot deal with the maximum DGD of 100 kHz. Therefore, 4-subcarrier configuration is selected as the candidate group (A). The number of subcarriers of 4 can also deal with the monitored maximum polarization fluctuation, and consequently, the number of subcarriers of 4 is determined lastly.

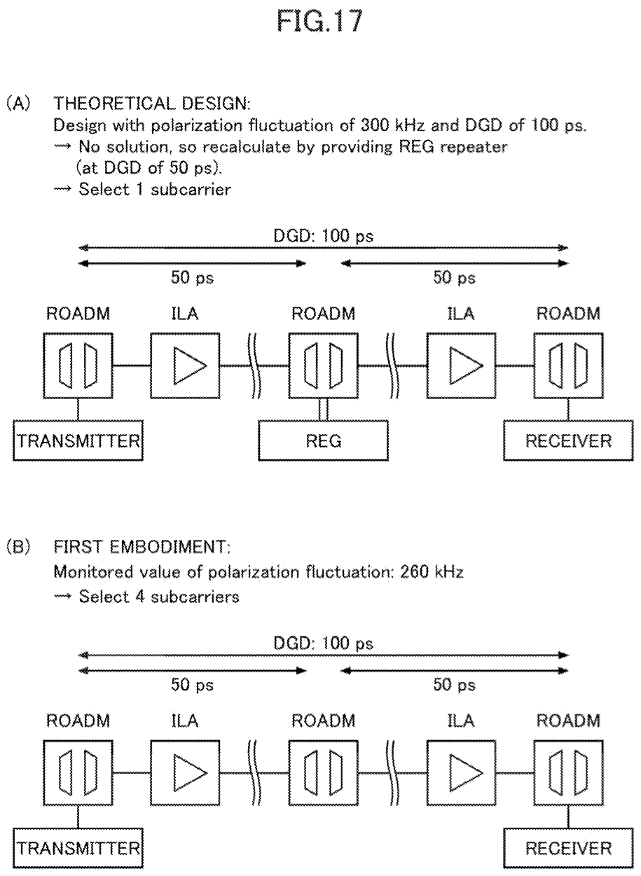

FIG. 17 illustrates a difference in network configuration between the theoretical design and the monitor-based design of the first embodiment shown in FIG. 16. Reconfigurable optical add drop multiplexers (ROADMs) illustrated in FIG. 17 are examples of the optical communication apparatus 10, and “ILA” corresponds to the in-line amplifier 53 (see FIG. 1). The transmitter and the receiver correspond to the transmitter-side configuration and the receiver-side configuration of the optical transceiver 30 connected to the optical communication apparatus 10. The theoretical design (a-1) illustrated in FIG. 17 (A) cannot provide a solution under the conditions of polarization fluctuation of 300 kHz and DGD of 100 ps. Therefore, a regenerative repeater REG is provided, and recalculation is performed under the condition of 50 ps DGD. The regenerative repeater REG is required for recalculation of the transmission line because the DGD tolerance is as low as 50 ps.

On the other hand, 4-subcarrier configuration is selected in FIG. 17 (B), which can deal with both the DGD and the polarization fluctuation of the transmission line under the conditions that the monitored polarization fluctuation is 260 kHz and that the maximum DGD is 100 ps. Using 4 subcarriers, the DGD tolerance is improved (see FIG. 5), and the regenerative repeater REG is no longer required. In other words, the transmission distance is doubled. The optimum number of subcarriers can be selected without the regenerative repeater REG when a new wavelength is added for a newly introduced optical transceiver or when an existing optical transceiver is rebooted.

### Second Embodiment

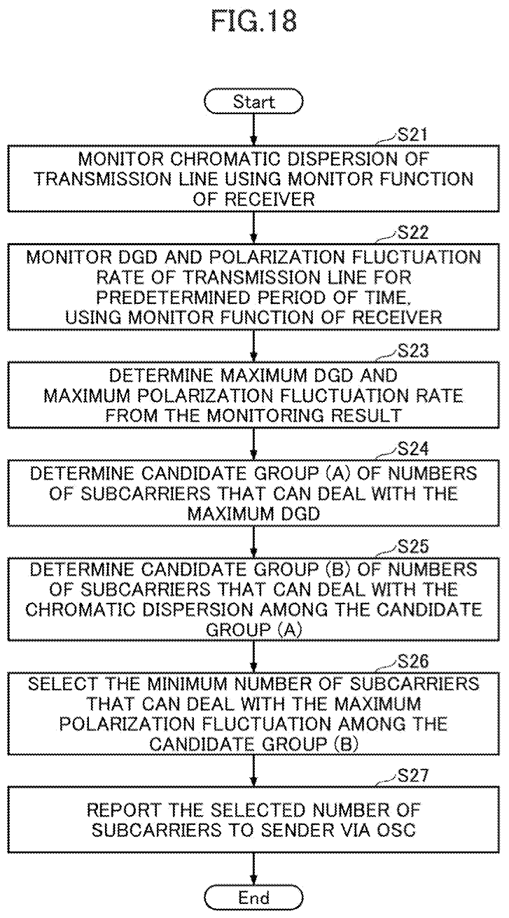

FIG. 18 is a flowchart of a method of determining the number of subcarriers according to the second embodiment. This operation flow is performed by an optical transceiver 30, such as the optical transceiver 30p illustrated in FIG. 1. In the second embodiment, chromatic dispersion is monitored, in addition to the DGD and polarization fluctuation of the transmission line, for a certain period of time. The numbers of subcarriers configurable in the optical transceiver 30 are narrowed to determine the first candidate group that can deal with the maximum DGD. Then, the numbers of subcarriers that can deal with the maximum chromatic dispersion are selected as the second candidate group from among the first candidate group. Lastly, the minimum number of subcarriers capable of dealing with the maximum polarization fluctuation is determined from the second candidate group, which is to be configured in the optical transceiver.

The optical transceiver 30 uses the chromatic dispersion estimator/monitor 355 of the Rx signal processor 35 of the DSP 33 to monitor the chromatic dispersion of the transmission line for a certain period of time (S21), and uses the dynamic equalizer 352 to monitor DGD and polarization fluctuation for a certain period of time (S22). The controller 38 of the optical transceiver 30 picks up the maximum DGD and the maximum polarization fluctuation from the monitoring result of the current monitoring period of time (S23), and determines a candidate group (A) for the numbers of subcarriers that can deal with the maximum DGD (324).

Then, the numbers of subcarriers that can deal with the monitored chromatic dispersion are selected from the candidate group (A), as the candidate group (B) (325). Among the candidate group (B), the minimum number of subcarriers that can deal with the maximum polarization fluctuation is selected as the number of subcarriers to be configured in the optical transceiver (S26). The determined number of subcarriers is reported by OSC to the optical communication apparatus 10-1 to which the counterpart optical transceiver 30i is connected, thereby configuring the number of subcarriers at both the transmitter side and the receiver side (327).

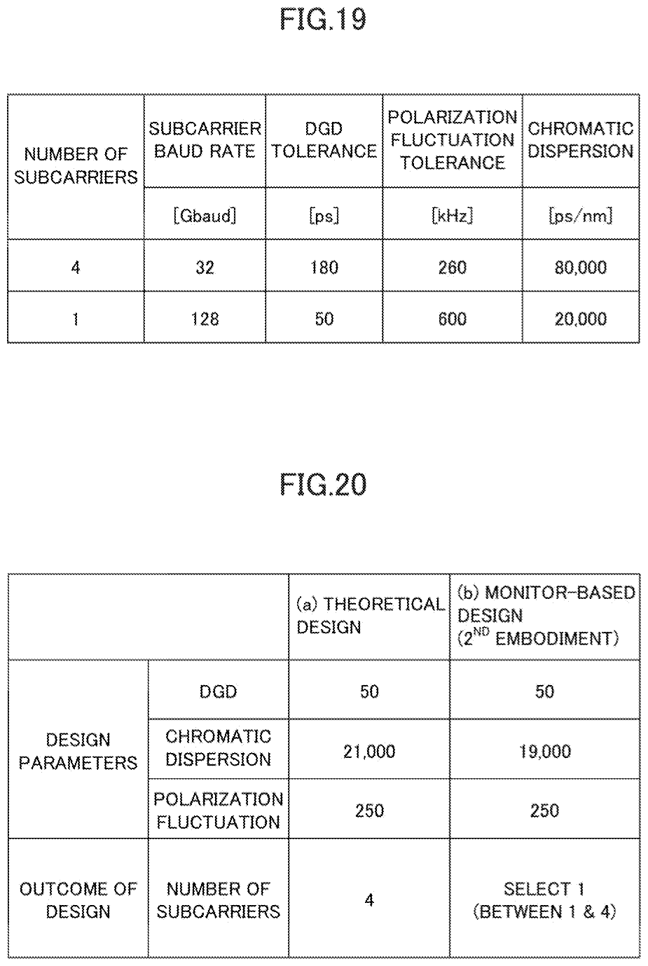

FIG. 19 illustrates the relationship between the number of subcarriers, subcarrier baud rate, DGD tolerance, polarization fluctuation tolerance, and chromatic dispersion. These parameters are determined according to the ability of the DSP 33. The operation mode is set to 600 Gbps, PCS-16 QAM, and 128 Gbaud as in the first embodiment. With a 4-subcarrier configuration, the subcarrier baud rate is 32 Gbaud, the DGD tolerance is 180 ps, the polarization fluctuation tolerance is 260 kHz, and the chromatic dispersion is 80,000 ps/nm. With a 1-subcarrier configuration, the subcarrier baud rate is 128 Gbaud, the DGD tolerance is 50 ps, the polarization fluctuation tolerance is 600 kHz, and the chromatic dispersion is 20,000 ps/nm. Although only the cases with the numbers of subcarriers of 1 and 4 are exemplified in the figure, the subcarrier baud rate, the DGD tolerance, and the polarization fluctuation tolerance are determined for each of 2\hat{ }n subcarriers, where n is an integer greater than or equal to 0, according to the ability of the DSP 33.

FIG. 20 illustrates a comparison between a theoretical design and a scheme of the second embodiment for determining the number of subcarriers. The theoretical design (a) determines the number of subcarriers by calculation without monitoring the transmission line. The monitor-based design (b) monitors the transmission line for a certain period of time, and determines the number of subcarriers that can deal with the maximum DGD, the maximum polarization fluctuation, and the chromatic dispersion of the transmission line, while minimizing SNR degradation, according to the second embodiment.

With the theoretical design, calculation is performed under the conditions of the maximum DGD of 50 ps, the chromatic dispersion of 21,000 ps/nm, and the polarization fluctuation of 250 kHz on the transmission line. According to the monitoring results, the maximum DGD is 50 ps, the chromatic dispersion is 19,000 ps/nm, and the maximum polarization fluctuation is 250 kHz. Referring to the DSP performance in FIG. 19, both the 1-subcarrier configuration and the 4-subcarrier configuration have a DGD tolerance of 50 ps or more, and a polarization fluctuation tolerance greater than 250 kHz. However, the 1-subcarrier configuration cannot deal with the chromatic dispersion of the transmission line, and accordingly, the 4-subcarrier configuration is inevitably selected.

In contrast, using the monitoring results according to the second embodiment, both the 1-subcarrier configuration and the 4-subcarrier configuration can deal with the monitored maximum DGD, the monitored maximum polarization fluctuation, and the monitored chromatic dispersion. Therefore, the 1-subcarrier configuration using the minimum number of subcarriers is selected. By selecting the minimum number of subcarriers, the SNR degradation can be minimized. Hence, the method of the second embodiment can select the optimum number of subcarriers capable of dealing, with multiple waveform distortion factors in a trade-off relationships.

As has been described above with reference to FIG. 15, the method of determining the number of subcarriers according to the second embodiment can have a margin for the SNR penalty by selecting the minimum number of subcarriers. This margin can be allocated to increase of the transmission capacity. For example, the transmission rate can be increased from 600 Gbps to 650 Gbps.

### Third Embodiment

In the third embodiment, chromatic dispersion is monitored, in addition to the DGD and polarization fluctuation of the transmission line, for a certain period of time. First, the numbers of subcarriers that can deal with the maximum DGD are selected as the first candidate group. Then, the numbers of subcarriers that can deal with the maximum chromatic dispersion are selected as the second candidate group, from among the first candidate group. Lastly, the number of subcarriers that can deal with the maximum polarization fluctuation and has the highest received Q factor is determined from the second candidate group. This method is advantageous for long-distance, low-multilevel transmission.

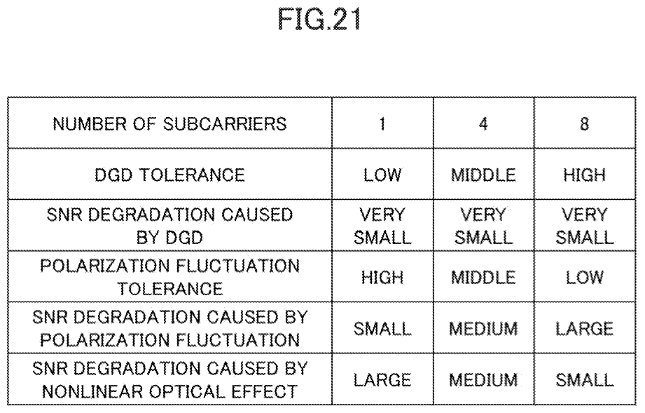

FIG. 21 illustrates the relationship between the number of subcarriers, DGD tolerance, polarization fluctuation tolerance, and SNR degradation. In addition to the SNR degradation caused by polarization fluctuation illustrated in FIG. 5, SNR degradation caused by the nonlinear optical effects is considered. As the number of subcarrier decreases, the SNR degradation due to the nonlinear optical effect of the fiber-optic cables of the transmission line increases. By increasing the number of subcarriers for long-distance, low-multilevel transmission, the tolerance to the nonlinear optical effect can be improved. This relation is opposite to the SNR degradation due to polarization fluctuation.

Considering the nonlinear optical effect of the transmission line, the maximum received Q factor may not be obtained even if the minimum number of subcarriers is selected. Therefore, in the third embodiment, the received Q factor is monitored and the number of subcarriers with the highest received Q factor is selected. The received Q factor can be monitored by received Q-factor monitors 356 and 357 (see FIG. 3) of the Rx signal processor 35 of the DSP 33.

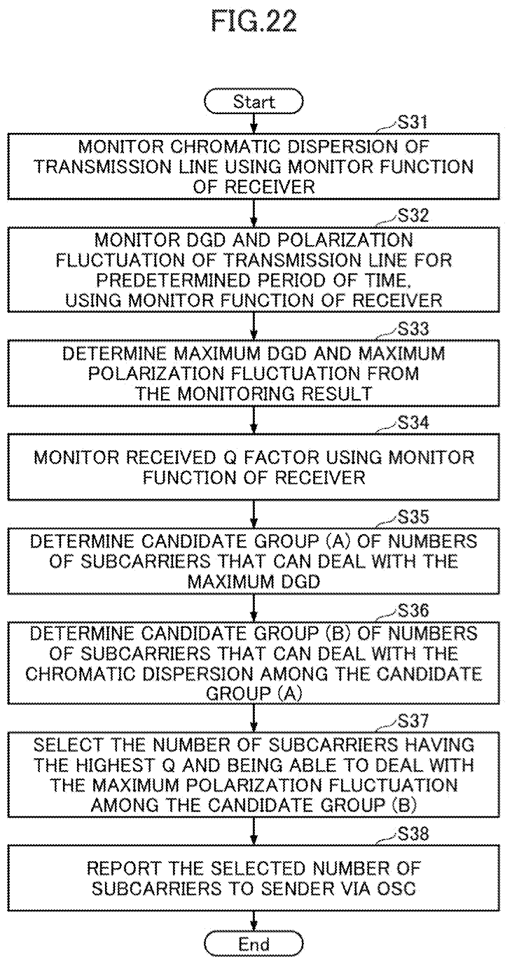

FIG. 22 is a flowchart of a method of determining the number of subcarriers according to the third embodiment. The optical transceiver 30 uses the chromatic dispersion estimator/monitor 355 of the Rx signal processor 35 of the DSP 33 to monitor the chromatic dispersion of the transmission line for a certain period of time (S31), and uses the dynamic equalizer 352 to monitor the DGD and polarization fluctuation on the transmission line for a certain period of time (S32). The controller 38 of the optical transceiver 30 determines the maximum DGD and the maximum polarization fluctuation in the monitored period, based on the monitoring results of the DGD and the polarization fluctuation (S33). On the other hand, the received Q-factor monitors 356 and 357 of the Rx signal processor 35 monitor the received Q-factors before and after the FEC decoding (S34).

Either step S33 (for determination of the maximum DGD and the maximum polarization fluctuation) or step S34 (for monitoring of the received Q-factors) may be performed first, or these steps may be simultaneously performed. Either one of the received Q factor before or after the FEC decoding may be used as the received Q factor. The received Q factor may be monitored immediately before step S37 for determining the number of subcarriers to be configured.

A candidate group (A) is determined with the numbers of subcarriers that can deal with the maximum DGD from among the numbers of subcarriers configurable in the optical transceiver 30 (S35). Then, the numbers of subcarriers that can deal with the monitored chromatic dispersion are selected as the candidate group (B) from the candidate group (A) (S36). Then, the number of subcarriers that can deal with the maximum polarization fluctuation and has the highest received Q factor is determined, from the candidate group (B), as the number of subcarriers to be configured in the optical transceiver (S37). The determined number of subcarriers is reported by CSC to the optical communication apparatus 10-1 to which the counterpart optical transceiver 30i is connected, thereby configuring the number of subcarriers at both the transmitter side and the receiver side (S38).

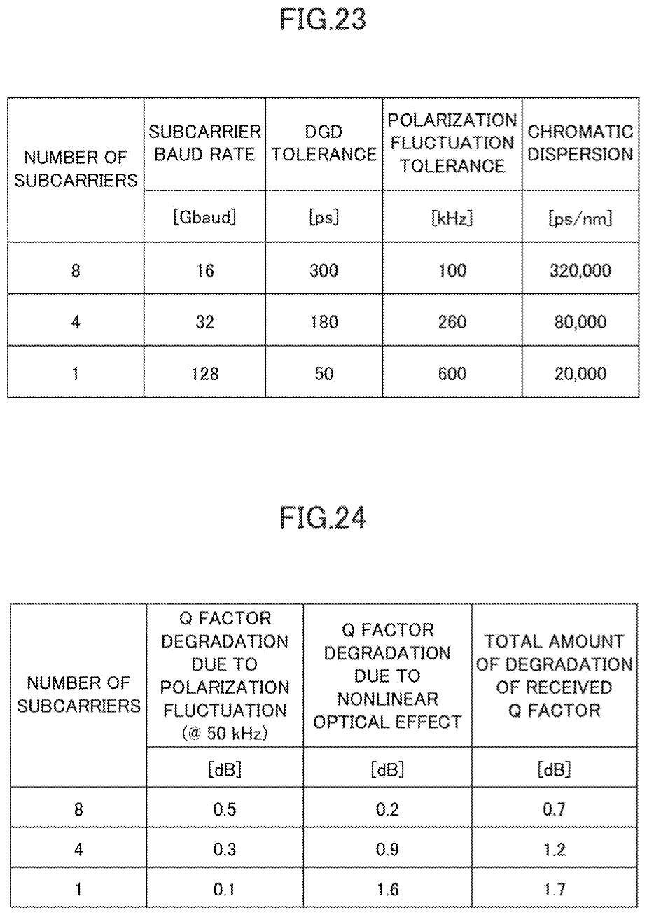

FIG. 23 illustrates the relationship between the number of subcarriers, subcarrier baud race, DGD tolerance, polarization fluctuation tolerance, and chromatic dispersion. These parameters are determined according to the ability of the DSP 33. The operating mode is set to 400 Gbps, QPSK, and 128 Gbaud, assuming long-distance transmission with a low order of multilevel modulation. With the 1-subcarrier configuration, the subcarrier baud rate is 128 Gbaud, the DGD tolerance is 50 ps, the polarization fluctuation tolerance is 600 kHz, and the chromatic dispersion is 20,000 ps/nm. With the 4-subcarrier configuration, the subcarrier baud rate is 32 Gbaud, the DGD tolerance is 180 ps, the polarization fluctuation tolerance is 260 kHz, and the chromatic dispersion is 80,000 ps/nm. With the 8-subcarrier configuration, the subcarrier baud rate is 16 Gbaud, the DGD tolerance is 300 ps, the polarization fluctuation tolerance is 100 kHz, and the chromatic dispersion is 320,000 ps/nm.

FIG. 24 illustrates a trade-off relationships between causes of degradation of a received Q factor. Polarization fluctuation and a nonlinear optical effect are main causes that degrade the received Q factor. When the number of subcarriers is 1, degradation of the received Q factor due to 50 kHz polarization fluctuation is 0.1 dB. The degradation of the received Q factor due to the nonlinear optical effect is 1.6 dB, and the total amount of degradation of the received Q factor is 1.7 dB.

When the number of subcarriers is 4, the degradation of the received Q factor due to SO kHz polarization fluctuation is 0.3 dB. The degradation of the received Q factor due to the nonlinear optical effect is 0.9 dB, and the total amount of degradation of the received Q factor is 1.2 dB. When the number of subcarriers is 8, the degradation of the received Q factor due to 50 kHz polarization fluctuation is 0.5 dB. The degradation of the received Q factor due to the nonlinear optical effect is 0.2 dB, and the total amount of degradation of the received Q factor is 0.7 dB.

The degradation of the received Q factor due to polarization fluctuation increases as the number of subcarriers increases. On the other hand, the degradation of the received Q factor due to the nonlinear optical effect increases as the number of subcarriers decreases. It is desirable for long-distance transmission to select the number of subcarriers that minimizes the degradation of the received Q factor, i.e., the number of subcarriers achieving the highest received Q factor, rather than the minimum number of subcarriers.

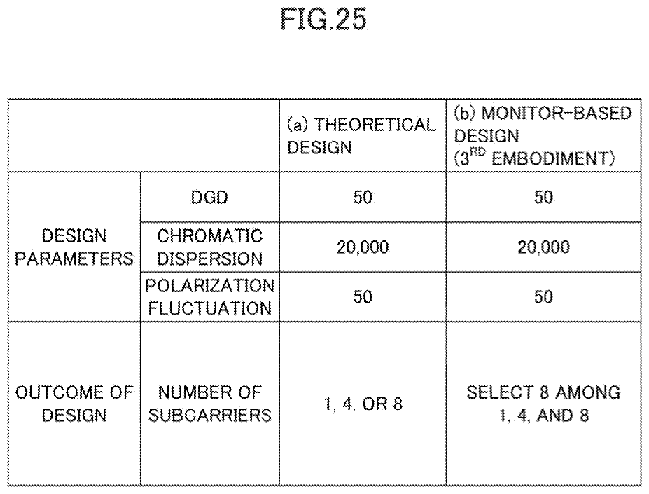

FIG. 25 illustrates a comparison between a theoretical design and the method of the third embodiment for determining the number of subcarriers. The theoretical design (a) determines the number of subcarriers by calculation without monitoring the transmission line. The monitor-based design (b) according to the third embodiment monitors the transmission line for a certain period of time to select the number of subcarriers that can deal with the maximum DGD, the maximum polarization fluctuation, and the chromatic dispersion of the transmission line, while minimizing the degradation of the received Q factor.

In the theoretical design, calculation is performed by setting the maximum DGD of 50 ps, the chromatic dispersion of 20,000 ps/nm, and the polarization fluctuation of 50 kHz on the transmission line. The monitoring results also indicate the maximum. DGD of 50 ps, chromatic dispersion of 20,000 ps/nm, and the maximum polarization fluctuation of 50 kHz. In the theoretical design, all the numbers of subcarriers 1, 4 and 8 can deal with the DGD, chromatic dispersion, and polarization fluctuation under the DSP performance shown in FIG. 23. Therefore, any one of 1, 4, and 8 subcarriers can be selected.

In contrast, with the method of the third embodiment, the number of subcarriers having the highest received Q factor is selected. Referring to FIG. 24, the 8-subcarrier configuration that minimizes the total amount of degradation of ole received Q factor selected. By selecting the 8-subcarrier configuration, the margin for the SNR penalty (see FIG. 15) is increased and contributed to the increase of the transmission capacity, as in the first and second embodiments, compared with the 1-subcarrier configuration. The transmission capacity can be increased, for example, from 600 Gbps to 650 Gbps.

Although the embodiments have been described above based on specific configuration examples, the present disclosure is not limited to the above-described embodiments. The number of subcarriers is not limited to 1, 4, or 8, and it may be 2, 16, or other numbers. Depending on the operating mode of the system to which the subcarrier modulation is applied, the method of the second embodiment or the method of the third embodiment may be selectively used. The method of configuring the number of subcarrers according to the first to third embodiments can be used not only when a new optical transceiver 30i is added, but also when an existing optical transceiver is rebooted. Thus, the optimum number of subcarrers can be configured in an optical communication system to which subcarrier modulation is applied.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of superiority or inferiority of the invention. Although the embodiments of the present inventions have been described in detail, it should be understood that the various changes, substitutions, and alterations could be made hereto without departing from the scope of the invention.

What is claimed is:

1. An optical transceiver to which subcarrier modulation is applied, the optical transceiver comprising:
a signal processor that monitors a differential group delay and polarization fluctuation of a transmission line for a predetermined period of time; and
a control processor determines, based on monitoring results of the differential group delay and the polarization fluctuation, a number of subcarriers to be configured in the optical transceiver from among candidates of numbers of subcarriers configurable in the optical transceiver, the numbers of subcarriers configurable in the optical transceiver being determined depending on an ability of a signal processor of the optical transceiver.

2. The optical transceiver as claimed in claim 1,
wherein the control processor selects a minimum number of subcarriers that can deal with a maximum polarization fluctuation monitored by the signal processor, from among a first candidate group that can deal with a maximum differential group delay.

3. The optical transceiver as claimed in claim 2,
wherein the signal processor monitors a chromatic dispersion of the transmission line, in addition to the differential group delay and the polarization fluctuation, for the predetermined period of time, and
wherein the control processor selects a number of subcarriers that can deal with a maximum chromatic dispersion, as a second candidate group, from among the first candidate group, and determines the minimum number of subcarriers that can deal with the maximum polarization fluctuation from among the second candidate group.

4. The optical transceiver as claimed in claim 2,
wherein the signal processor monitors a chromatic dispersion of the transmission line, in addition to the differential group delay and the polarization fluctuation, for the predetermined period of time, and
wherein the control processor selects a number of subcarriers that can deal with a monitored maximum chromatic dispersion, as a second candidate group, from among the first candidate group, and determines a number of subcarriers that can deal with the maximum polarization fluctuation and has the minimum number of subcarriers or a highest received Q factor.

5. The optical transceiver as claimed in claim 4,
wherein the signal processor monitors the received Q factor for the predetermined period of time, and
wherein the control processor selects the number of subcarriers that can deal with the maximum polarization fluctuation and has the highest received Q factor, as the number of subcarriers to be configured in the optical transceiver.

6. The optical transceiver as claimed in claim 1,
wherein the signal processor has an equalizer, and
wherein the equalizer has an adaptive equalization filter, a calculator that calculates a filter coefficient of the adaptive equalization filter, and a monitor that determines a polarization fluctuation rate from a calculation result of the filter coefficient.

7. The optical transceiver as claimed in claim 6,
wherein the equalizer has a step-size selector that selects a step size for calculating the filter coefficient based on a monitoring result of the monitor.

8. The optical transceiver as claimed in claim 1,
wherein information of the determined number of subcarriers is transmitted to a counterpart optical transceiver.

9. An optical communication apparatus comprising:
an optical transceiver to which subcarrier modulation is applied; and
a node controller that supplies a number of subcarriers determined by the optical transceiver to a counterpart optical communication apparatus located at an opposite end of a transmission line,
wherein the optical transceiver includes
a signal processor that monitors a differential group delay and polarization fluctuation of the transmission line for a predetermined period of time; and
a control processor that determines the number of subcarriers to be configured in the optical transceiver from among candidates of numbers of subcarriers configurable in the optical transceiver, the numbers of subcarriers configurable in the optical transceiver being determined depending on an ability of a signal processor of the optical transceiver.

10. An optical communication system comprising:
a first optical communication apparatus;
a second optical communication apparatus; and
a transmission line connecting the first optical communication apparatus and the second optical communication apparatus,
wherein an optical transceiver in the second optical communication apparatus monitors a differential group delay and a polarization fluctuation of the transmission line for a predetermined period of time, and selects a number of subcarriers to be configured in the optical transceiver in the second optical communication apparatus, from among candidates of numbers of subcarriers configurable in the optical transceiver and determined by an ability of a signal processor of the optical transceiver, based upon monitoring results of the differential group delay and the polarization fluctuation,
wherein the second optical communication apparatus reports the number of subcarriers determined by the optical transceiver to the first optical communication apparatus, and
wherein the first optical communication apparatus configures the number of subcarriers in a counterpart optical transceiver.

11. The optical communication system as claimed in claim 10,
wherein the optical transceiver in the second optical communication apparatus monitors the differential group delay and the polarization fluctuation of the transmission line when the counterpart optical transceiver is added or rebooted in the first optical communication apparatus.

12. A method of determining a number of subcarriers, comprising:
monitoring, by an optical transceiver to which subcarrier modulation is applied, a differential group delay and a polarization fluctuation of a transmission line for a predetermined period of time; and
determining, by the optical transceiver, based on monitoring results of the differential group delay and the polarization fluctuation, a number of subcarriers to be configured in the optical transceiver from among candidates of numbers of subcarriers configurable in the optical transceiver, the numbers of subcarriers configurable in the optical transceiver being determined depending on an ability of a signal processor of the optical transceiver.

13. The method as claimed in claim 12, comprising:
determining, by the optical transceiver, a minimum number of subcarriers that can deal with a maximum polarization fluctuation in the monitoring results, from among a first candidate group that can deal with a maximum differential group delay.

14. The method as claimed in claim 13, comprising:
monitoring, by the optical transceiver, a chromatic dispersion of the transmission line, in addition to the differential group delay and the polarization fluctuation, for the predetermined period of time;
selecting, by the optical transceiver, numbers of subcarriers that can deal with a maxim chromatic dispersion, as a second candidate group, from among the first candidate group, and
determining, by the optical transceiver, the minimum number of subcarriers that can deal with the maximum polarization fluctuation from among the second candidate group.

15. The method as claimed in claim 13, comprising:
monitoring, by the optical transceiver, a chromatic dispersion of the transmission line, in addition to the differential group delay and the polarization fluctuation, for the predetermined period of time;
selecting, by the optical transceiver, numbers of subcarriers that can deal with a maximum chromatic dispersion, as a second candidate group, from among the first candidate group; and
determining, by the optical transceiver, a number of subcarriers that can deal with the maximum polarization fluctuation and has the minimum number of subcarriers or a highest received Q factor.

16. The method as claimed in claim 15, comprising:
monitoring, by the optical transceiver, the received Q factor for the predetermined period of time; and
determining, by the optical transceiver, the number of subcarriers that can deal with the maximum polarization fluctuation and has the highest received Q factor, as the number of subcarriers to be configured in the optical transceiver.
